(19) United States
(12) Patent Application Publication
(10) Pub. No.: US 2012/0259719 A1
(43) Pub. Date: Oct. 11, 2012

(54) Point of Sale Enhancement System and Method

(76) Inventors: Kfir Bar-Levav, Elad (IL); Ofer Yourvexel, Kfar Haruzim (IL); Amir Lisser, Ramot-Hashavim (IL)

(21) Appl. No.: 13/131,868

(22) PCT Filed: Oct. 17, 2010
(86) PCT No.: PCT/IB10/54695

§ 371 Date: May 30, 2011

(51) Int. Cl. G06Q 20/20

(52) U.S. Cl. 705/21

(57) ABSTRACT

A system for point of sale enhancement, the system comprising: a control data capturer, configured to capture control data of an operation on a POS (Point of sale) terminal computer of a first party, a transaction data extractor, in communication with the control data capturer, configured to extract transaction data from the captured control data, a query issuer, in communication with the transaction data extractor, configured to issue a query based on the extracted transaction data, and a remote computer of an intermediary party, in remote communication with the query issuer, configured to receive the query and generate a result for the received query, using information provided by a third party through remote communication to the remote computer.

### FIELD AND BACKGROUND OF THE INVENTION

The present invention relates to Point of Sale (POS) systems, POS terminals and cash registers, and more particularly, but not exclusively to POS enhancement systems and methods.

In recent years, a wide range of Point of Sale (POS) systems have been developed on platforms such as Microsoft™ Windows and a variety of Unix operating systems.

The availability of local processing power, local data storage, networking, and graphical user interface has made it possible to develop flexible and highly functional POS systems. Further, the cost of Point of Sale (POS) systems has also declined, as many POS components can now be purchased off-the-shelf.

Retailing industry businesses have become probably the most predominant users of Point of Sale (POS) systems.

Many Retail Point of Sales systems, used by small retail businesses, include a single POS terminal.

Other Retail Point of Sales systems include a few POS terminals.

A POS terminal manages the selling process by a salesperson accessible interface.

A POS terminal typically includes a computer and monitor.

Optionally, the POS terminal further includes a cash drawer, for keeping cash paid in sale transaction carried out using the POS terminal.

Optionally, the POS terminal computer includes other peripherals, such as a receipt printer, a customer display and a barcode scanner.

The POS terminal may also include peripherals such as a weight scale, an integrated credit card processing system, a signature capture device, or other peripherals.

Many POS terminals are equipped with a monitor which has touch-screen technologies for ease of use and a computer built into the monitor's chassis, for what is referred to as an all-in-one unit. The all-in-one unit saves counter space which is very valuable for a small retailer.

The POS terminal computer is installed with POS software which typically handles a myriad of customer based functions such as sales, returns, exchanges, customer loyalty programs, quantity discounts etc.

The POS computer may use one or more of several communication protocols, currently available for controlling the peripherals of the POS terminal.

Among the protocols are command protocols such as EPSON™ Esc/POS, the UTC™ Standard, UTC™ Enhanced standard, AEDEX, ICD 2002, CD 5220, DSP-800, ADM 787/788, etc.

Many POS peripherals, such as displays and printers, support several of the command protocols, in order to work with many different brands of POS terminal computers.

Some POS systems further include a back-office computer.

The back-office computer typically handles a variety of other functions of the POS system, such as inventory control, purchasing, returns to suppliers, report generation (for business and tax purposes), etc.

Some POS systems also include an accounting interface which feeds sales and cost of goods data to independent accounting applications.

### SUMMARY OF THE INVENTION

According to one aspect of the present invention there is provided a system for point of sale enhancement.

The system comprises: a control data capturer, configured to capture control data of an operation on a POS (Point of sale) terminal computer of a first party, a transaction data extractor, in communication with the control data capturer, configured to extract transaction data from the captured control data, and a query issuer, in communication with the transaction data extractor, configured to issue a query based on the extracted transaction data. The system further comprises a remote computer of an intermediary party, in remote communication with the query issuer, configured to receive the query and generate a result for the received query, using information provided by a third party through remote communication to the remote computer.

According to a second aspect of the present invention there is provided an apparatus for point of sale enhancement.

The apparatus comprises: a control data capturer, configured to capture control data of an operation on a POS (Point of sale) terminal computer of a first party, a transaction data extractor, in communication with the control data capturer, configured to extract transaction data from the captured control data, and a query issuer, in communication with the transaction data extractor, configured to issue a query based on the extracted transaction data against a remote computer of a second party.

According to a third aspect of the present invention there is provided a computer implemented method for point of sale enhancement.

The method comprises steps the computer is programmed to perform.

The steps comprise: a) capturing control data of an operation on a POS (Point of sale) terminal computer of a first party, b) extracting transaction data from the captured control data, and c) issuing a query based on the extracted transaction data against a remote computer of a second party.

According to a fourth aspect of the present invention there is provided a computer readable medium storing computer executable instructions for performing steps of point of sale enhancement.

The steps comprise: a) capturing control data of an operation on a POS (Point of sale) terminal computer of a first party, b) extracting transaction data from the captured control data, and c) issuing a query based on the extracted transaction data against a remote computer of a second party.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a block diagram schematically illustrating a first system for point of sale enhancement, according to an exemplary embodiment of the present invention.

FIG. 2 is a block diagram schematically illustrating a second system for point of sale enhancement, according to an exemplary embodiment of the present invention.

FIG. 3 is a block diagram schematically illustrating an apparatus for point of sale enhancement, according to an exemplary embodiment of the present invention.

FIG. 4 is a flowchart illustrating a computer implemented method for point of sale enhancement, the method comprising steps the computer is programmed to perform.

FIG. 5 is a block diagram schematically illustrating a computer readable medium storing computer executable instructions for performing steps of point of sale enhancement.

### DESCRIPTION OF THE PREFERRED EMBODIMENTS

The present embodiments comprise an apparatus, a system and a method for point of sale enhancement.

According to an exemplary embodiment of the present invention, a POS (Point-of-Sale) terminal computer of a first party (say a retailer) is enhanced, by adding to the POS terminal computer, automatic functionality which provides for cross-selling, up-selling and other sale activities.

The added functionality is based on information provided by second parties, say other retailers (fashion boutiques, pharmacies, etc.), through a virtual network based on a computer network (such as the internet), as described in further detail hereinbelow.

Optionally, the information is provided directly by the second parties, in a peer-to-peer connection, as known in the art. Alternatively the information is provided through services of an intermediary party which manages a database of services and products offers by the second parties, as described in further detail hereinbelow.

In one example, the parties are pharmacies and health food stores. Each of the pharmacies operates a POS (Point-of-sale) terminal computer used as a cash register, as well as for recording sale transactions (say drug dispensing to patients).

When a pharmacist sells a certain drug to a patient, the pharmacist scans the drug's package, using a bar code reader connected to the POS (Point-of-sale) terminal computer.

Then, control data of the package's scanning is captured and analyzed.

Consequently, transaction data identifying the drug sold is extracted from the captured and analyzed control data of the scanning.

Next, a query based on the transaction data is sent to a remote computer of an intermediary party.

Optionally, the query includes information provided by the pharmacist, the patient, or both, through a Graphical User Interface (GUI), say information on the patient's age or sex, in addition to the transaction data automatically extracted from the control data.

The query may include at least a part of the extracted transaction data, an indication as to the type of information sought (say products or services offered by third parties), etc.

The remote computer retrieves cross-selling related information from a database fed with information provided earlier by health food stores (say a certain health food product promotion available from a certain health food store), and sends the information as a result, to the POS terminal computer.

By providing the information, the third party registers his services and products with the remote computer, thus exposing the services and product to other parties, say retailers in the third party's field, in a field complementary to the third party's field, etc.

Finally, the POS terminal computer presents a proposal based on the result on a screen of the POS terminal computer, to the pharmacist, thus enhancing the drug sale transaction carried out using the POS terminal computer with cross-selling information. The pharmacist tells the patient about the health food product, and the patient may ask the pharmacist to order the health food product.

That is to say that with an exemplary embodiment of the present invention, there is provided an ability to offer cross and up sell offerings among retailers and other parties (such as retailers in the same field or in a complementary field).

The principles and operation of a system, apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

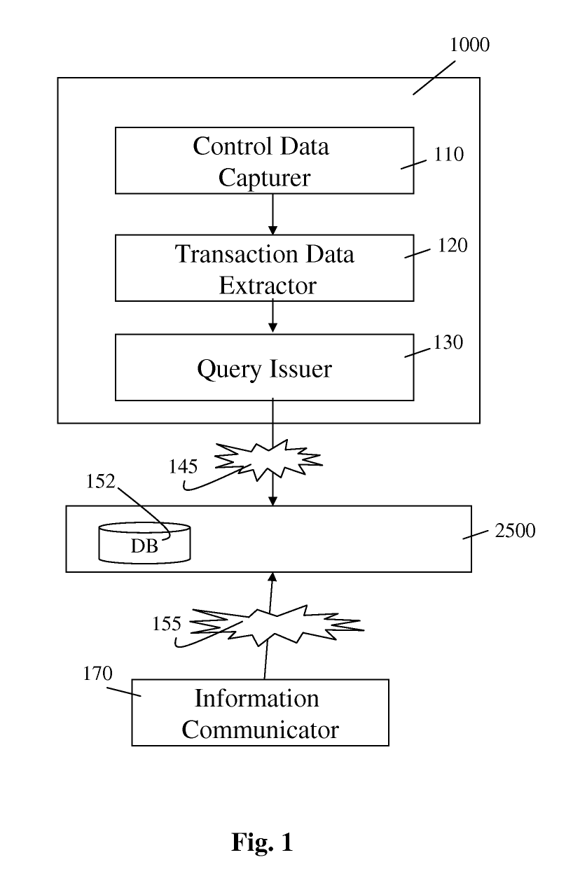

Reference is now made to FIG. 1, which is a block diagram schematically illustrating a first system for point of sale enhancement, according to an exemplary embodiment of the present invention.

A system according to an exemplary embodiment of the present invention includes a control data capturer 110, a transaction data extractor 120, and a query issuer 130.

Each of the three 110, 120, 130 may be installed on a POS (Point-of-sale) terminal computer 1000 of a first party (say a retailer such as a grocery shop or an electric appliance store), on a computer in communication with the POS terminal computer 1000, or on a portable device connectable to the POS terminal computer 1000, as described in further detail hereinbelow.

Optionally, the portable device is a USB Memory, a USB connectable cellular modem (such as a Falcom™ Samba3G wireless modem), etc., as known in the art.

Each of the three 110, 120, 130 may be implemented as software, as hardware, or as a combination of software and hardware.

The control data capturer 110 captures control data of an operation on a POS (Point of sale) terminal computer 1000 of the first party, or on a peripheral of the POS terminal computer 1000.

The peripheral of the POS computer terminal may include, but is not limited to: a peripheral connected to the POS terminal computer 1000 (say a screen, a computer mouse or a printer), a peripheral implemented on the POS terminal computer 1000 (say an internet connection), etc., as known in the art.

The peripheral may include, but is not restricted to: a bar code reader, a touch screen, a magnetic card reader, an internet connection, a modem, a computer mouse, a keyboard, a USB port, a graphical computer card, a printer, or any other peripheral device connected to the POS terminal computer 1000.

In one example, the peripheral is a touch screen connected to the POS terminal computer 1000, and the control data is generated upon a finger touch on a certain area of the touch screen (say a finger touch used to select a product among a few products presented on the touch screen).

In a second example, the peripheral is a printer in communication with the POS terminal computer 1000, and the control data is generated upon a printing operation carried out on the printer.

Typically, the control data is communicated between the POS terminal computer 1000 and the peripheral (such as a touch screen, a printer, a bar code reader, etc.), through one of a several communication protocols currently available for controlling peripherals of a POS terminal.

Among the protocols are command protocols such as EPSON™ Esc/POS, the UTC™ Standard, UTC™ Enhanced standard, AEDEX, ICD 2002, CD 5220, DSP-800, ADM 787/788, etc.

Optionally, the control data capturer 110 captures the control data by intercepting Microsoft™ Operating System messages, as described in further detail hereinbelow.

Optionally, the control data capturer 110 captures the control data by hooking Postscript data from a UNIX operating system printer driver, etc., as described in further detail hereinbelow.

The transaction data extractor 120 communicates with the control data capturer 110, for receiving the control data captured by the control data capturer 110.

The transaction data extractor 120 extracts transaction data from the control data captured by the data capturer 110.

Optionally, the extracted transaction data pertains to a sale transaction carried out on the POS terminal computer 1000.

Optionally, the transaction data extractor 120 extracts the sale transaction data, by identifying a predefined sequence of operations carried out on the POS terminal computer or on the terminal computer's peripheral, by extracting relevant information from the control data.

For example, when a scanning of an item's bar code is followed by a scanning of bar codes of several substitute items, the transaction data extractor 120 identifies a customer's effort to choose among several alternative brands, and extracts the sale transaction data (i.e. brands of the items) from the control data.

In one example, the control data includes printing commands issued from a printer's driver.

Optionally, the printing commands include string parameters such as a sold product's name, quantity and price, to be printed on an invoice, as well parameters for controlling the position of the printing, color of printing, line skipping, etc.

The transaction data extractor 120 extracts transaction data such the sold product's name, an amount sold, a price, etc., from the control data. Optionally, the control data includes Postscript printing commands, and the transaction data extractor 120 extracts the transaction data from textual and graphical parameters of the Postscript commands, as described in further detail hereinbelow.

The query issuer 130 communicates with the transaction data extractor 120, for receiving the transaction data extracted by the transaction data extractor 120.

The query issuer 130 issues a query based on the extracted transaction data, for retrieving information relevant for cross-selling, up-selling, or another sale activity, from a remote computer 2500.

Optionally, the query includes data provided by a cashier who operates the POS terminal computer (say through a Graphical User Interface), in addition to the transaction data automatically extracted from the control data.

The system of the exemplary embodiment further includes a remote computer 2500 of an intermediary party.

The remote computer 2500 is in remote communication with the query issuer 130 over a network 145 such as the internet or another computer network.

The remote computer 2500 receives the query and generates a result for the received query, based on data included in the query, using information provided by a third party through remote communication to the remote computer 2500.

For example, the remote computer 2500 may use the query to retrieve information pertaining to a sales proposal originating from one or more third parties, from a dedicated database 152.

The retrieved information may include, but is not limited to: promotional sale information, say information about a third party's product related to a product sold on the POS terminal computer 1000, coupons available from another third party, a movie presented in a Cinema Theater not far from the first party, etc.

Optionally, the system of the exemplary embodiment further includes an information communicator 170, implemented on a computer of the third party.

The information communicator 170 communicates the information from the third party to the remote computer 2500, through a computer network 155, such as the internet or another computer network.

Each of the third parties may use an information communicator 170, for communicating information about products, services, promotions, etc., to the remote computer 2500.

Optionally, the remote computer stores the information from the third party on a dedicated database 152.

Optionally, the system of the present exemplary embodiment further includes a proposal presenter installed on the POS (Point-of-sale) terminal computer 1000, or on the portable device connectable to the POS terminal computer 1000.

The proposal presenter may be implemented as software, as hardware, or as a combination of software and hardware.

The proposal presenter receives the result of the query and presents a proposal based on the result, on a screen of the POS terminal computer 1000, thus enhancing a sale transaction carried out using the POS terminal computer with the information provided by the third party, as described in further detail hereinbelow.

Optionally, the information provided by the third party includes a sale offer, and the result and the offer are based on the sale offer.

In one example, the proposal presenter presents a cross-selling proposal based on the query's result, by presenting information on an item related to an item sold to a client, using the POS terminal computer 1000, on a screen of the POS terminal computer 1000.

In a second example, the proposal presenter presents an up-selling proposal based on the query's result, by presenting information on an item more expensive than an item a customer wishes to buy, but more luxurious, on a screen of the POS terminal computer 1000.

Optionally, both the first party and the third party are retailers, say pharmacies, groceries, fashion boutiques, electric appliance stores, etc., as described in further detail hereinbelow.

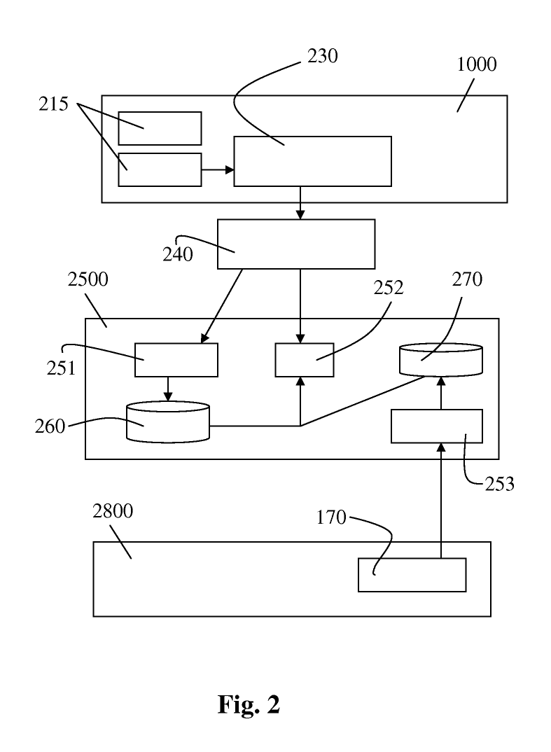

Reference is now made to FIG. 2, which is a block diagram schematically illustrating a second system for point of sale enhancement, according to an exemplary embodiment of the present invention.

In a second exemplary system according to an exemplary embodiment of the present invention, the control data capturer 110, the transaction data extractor 120, and the query issuer 130 (described in further detail hereinabove) are implemented as a set of computer executable instructions stored on a computer readable medium 240, say on a USB Memory combined with a modem, as described in further detail hereinbelow.

The instructions are stored in executable files, on the computer readable medium 240, together with data files to be used by the instructions. The data files may include configuration data which defines the POS terminal computer's 1000 peripherals, characteristics of control data the control data capturer 110 needs to capture, characteristics of the transaction data to be extracted, etc., as described in further detail hereinbelow.

Optionally, the computer readable medium 240 further includes a modem, for sending the query issued by the query issuer 130 to the remote computer 2500, as described in further detail hereinabove.

The POS terminal computer further includes a client program 230. The client program 230 loads the instructions from the computer readable medium 240, and initiates the execution of the instructions, thus activating the control data capturer 110, the transaction data extractor 120 and the query issuer 130.

Optionally, the computer readable medium 240 further stores computer executable instructions of a preference information communicator and a proposal presenter (as described in further detail hereinbelow), which are also activated by the client program 230, by loading and initiating execution of the instructions.

The query issued by the query issuer 130 is based on the transaction data extracted by the transaction data extractor 120. The control data is captured, from the POS terminal computer's 1000 peripheral(s) 215, by the control data capturer 110, as described in further detail hereinabove.

The remote computer 2500 receives and generates a result for the query, using a data retrieval utility 252, which retrieves information provided by a third party which fits data included in the query, from a third party product registry 270. The third party product registry 270 may be implemented on a database 152, as described in further detail hereinabove, using a DBMS (Data Base Management System), as known in the art.

Optionally, the information in the third party product registry 270 is communicated to the remote computer 2500, from a computer 2800 of the third party, say using the information communicator 170, as describe in further detail hereinabove. The information from the third party is added to the third party product registry 270, say by a database update utility 253 for updating a DBMS managed database, as known in the art.

Optionally, the first party may use a preference information communicator, for communicating preference information to the remote computer 2500. The preference information is received by a second database update utility 251, which stores the preference information in a POS party product registry 260. Consequently, the data retrieval utility 252 uses the preference data together with the data in the query received from the first party, for generating the result for the query, as described in further detail hereinbelow.

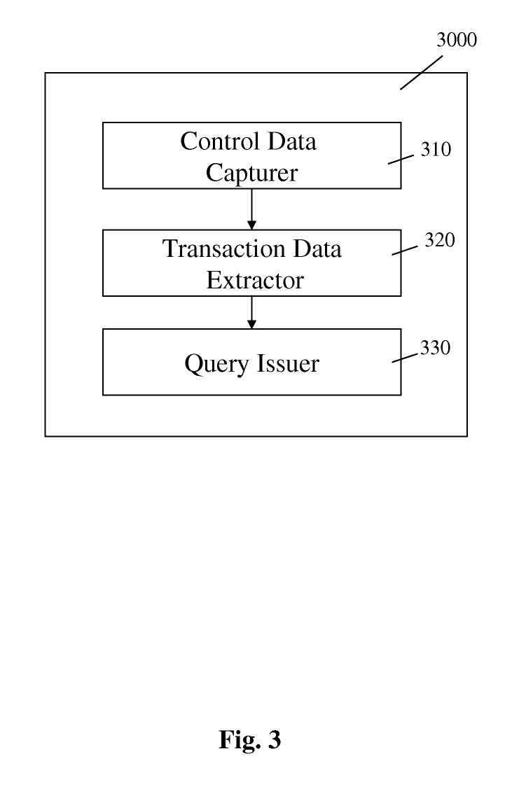

Reference is now made to FIG. 3, which is a block diagram schematically illustrating an apparatus for point of sale enhancement, according to an exemplary embodiment of the present invention.

An exemplary apparatus 3000 may be installed on a POS (Point-of-sale) terminal computer of a first party (say a retailer such as a grocery shop or an electric appliance store), on a portable device connectable to the POS terminal computer, or partially on the POS terminal computer and partially on the portable device. Further, some parts of the apparatus may be implemented on a computer in communication with the POS terminal computer, as described in further detail hereinabove, and illustrated using FIG. 1.

Optionally, the portable device is a USB Memory, a USB connectable cellular modem (such as a Falcom™ Samba3G wireless modem), etc., as known in the art.

The apparatus 3000 may be implemented as software, as hardware, or as a combination of software and hardware.

Apparatus 3000 includes a control data capturer 310.

The control data capturer 310 captures control data of an operation on a POS (Point of sale) terminal computer of the first party or on a peripheral of the POS terminal computer of the first party.

The peripheral of the POS computer terminal may include, but is not limited to: a peripheral connected to the POS terminal computer (say a screen, a mouse, or a keyboard), a peripheral implemented on the POS terminal computer (say an internet connection), etc., as known in the art.

The peripheral may include, but is not restricted to: a bar code reader, a touch screen, a magnetic card reader, an internet connection, a modem, a computer mouse, a keyboard, a USB port, a graphical computer card, a printer, or any other peripheral device connected to the POS terminal computer.

In one example, the peripheral is a touch screen connected to the POS terminal computer, and the control data is generated upon a finger touch on a certain area of the touch screen (say a finger touch used to select a product among a few products presented on the touch screen).

In a second example, the peripheral is a printer in communication with the POS terminal computer, and the control data is generated upon a printing operation carried out on the printer.

Typically, the control data is communicated between the POS terminal computer and the peripheral (such as a touch screen, a printer, a bar code reader, etc.), through one of a several communication protocols currently available for controlling peripherals of a POS terminal.

Among the protocols are command protocols such as EPSON™ Esc/POS, the UTC™ Standard, UTC™ Enhanced standard, AEDEX, ICD 2002, CD 5220, DSP-800, ADM 787/788, etc.

Optionally, the control data capturer 310 captures the control data by intercepting operating system messages.

For example, Microsoft™ Windows Operating System allows to insert hooks that can be used to process or modify system messages and application events for dialogs, scrollbars, and menus as well as other items. Microsoft™ Windows also allows a hook to insert, remove, process or modify keyboard events, mouse events, etc.

Similarly, the Linux Operating System Linux provides the Net-filter framework. Net-filter is a framework that provides hook handling within the Linux Operating system's kernel, for intercepting and manipulating network packets

Optionally, the control data capturer 310 captures the control data by hooking Postscript data from a UNIX operating system printer driver or from a printing server.

For example, some retailers may have a local network of POS terminal computers and a server installed with CUPS (Common Unix Printing System).

CUPS is a modular printing subsystem for Unix operating systems.

CUPS consists of a print spooler, a print job scheduler, a filter system that converts the print data to a format that a printer understands, and a backend system that sends this data to the printer.

CUPS provides a mechanism which allows print jobs to be sent to printers in a standard fashion. With CUPS, a print job is sent to a scheduler, which sends the print job to a filter system. The filter system converts the print job into a format the printer understands. The filter system then passes print job on, to a backend special filter which sends print data of the print job, to a printing device or a network connection.

In a local network of POS terminal computers, which utilizes CUPS, there may be installed and configured a Postscript Virtual Printer Driver, as known in the art. The Postscript Virtual Printer Driver utilizes a backend code based on CUPS APIs (Application Program Interfaces), to hook Postscript print data of all print jobs received a CUPS printing subsystem installed on the local network.

Apparatus 3000 further includes a transaction data extractor 320, in communication with the control data capturer 310.

The transaction data extractor 320 extracts transaction data from the control data captured by the data capturer 310.

Optionally, the control data capturer 310 stores the control data in a dedicated peripheral log information database, and the transaction data extractor 320 extracts the transaction data from the logged control data, in a batch process initiated every few minutes.

Optionally, the control data capturer 310 forwards the captured control data directly, to the transaction data extractor 320.

Optionally, the transaction data extractor 320 is customized (say by an operator of the apparatus 3000), using a graphical user interface (GUI), as known in the art.

Optionally, the extracted transaction data pertains to a sale transaction carried out on the POS terminal computer of the first party.

Optionally, the transaction data extractor 320 extracts the sale transaction data, by identifying a predefined sequence of operations carried out on the POS terminal computer or on the terminal computer's peripheral, by extracting relevant information from the control data.

For example, when a scanning of an item's bar code is followed by a scanning of bar codes of several substitute items, the transaction data extractor 120 identifies a customer's effort to choose among several alternative brands, and extracts the sale transaction data (i.e. brands of the items) from the control data.

In one example, the control data includes printing commands issued from a printer's driver.

Optionally, the printing commands include string parameters such as a sold product's name, quantity and price, to be printed on an invoice, as well parameters for controlling the position of the printing, color of printing, line skipping, etc.

The transaction data extractor 320 extracts transaction data such the sold product's name, an amount sold, a price, etc., from the control data. Optionally, the control data includes Postscript printing commands, and the transaction data extractor 320 extracts the transaction data from textual and graphical parameters of the Postscript commands, as described in further detail hereinbelow.

Optionally, the transaction data extractor 320 is configured to extract the transaction data according to a workflow pattern predefined, say by an operator of the apparatus 3000.

Exemplary workflow patterns include, but are not limited to:
extracting an item code from captured barcode reader control data.
extracting a product name from captured control data of a printing operation (say a send to print command).
extracting a customer name from captured control data of a printing operation.
extracting a phone number (using a predefined phone number pattern) from captured control data of a printing operation.
detecting a sale upon capturing of control data generated when a credit card is read by a card reader

Apparatus 3000 further includes a query issuer 330, in communication with the transaction data extractor 320.

The query issuer 330 issues a query based on the extracted transaction data, for retrieving information relevant for cross-selling, up-selling, or another sale activity, from a remote computer of a second party.

Optionally, the query includes data provided by a cashier who operates the POS terminal computer (say through a Graphical User Interface), in addition to the transaction data automatically extracted from the control data. For example, the cashier may provide data pertaining to a customer's age, sex, etc.

Optionally, both the first party and the second party are retailers, say groceries, fashion boutiques, electric appliance stores, etc.

Optionally, the first party is a retailer, whereas the second party is an intermediary, and the remote computer of the intermediary receives the query and generates a result for the received query, using data included in the query and information provided by a third party. The third party may be second retailer, or another business entity. The third party provides the information to the intermediary through a remote communication to the remote computer, as described in further detail hereinabove.

Optionally, both the first party and the third party are retailers, say pharmacies, groceries, fashion boutiques, electric appliance stores, etc., as described in further detail hereinbelow.

In one example, the remote computer uses the query to retrieve information pertaining to a sales proposal originating from the third party, from a dedicated database, thus generating a result for the query.

The retrieved information may include, but is not limited to: promotional sale information, say information about a third party's product related to a product sold on the POS terminal computer, coupons available from a third party, a movie presented in a Cinema Theater not far from the first party, etc.

The information retrieved may depend on the transaction data the query is based on.

In one example, the query data includes transaction data indicating that the transaction is a sale together with a sold product's name. Consequently, the retrieved information may include accessory items, an offer for extended warranty, etc.

In a second example, the transaction data includes a client's birth date. Consequently, the retrieved information may include a present, such as two tickets to a movie, etc.

The retrieved information may serve to enhance the POS terminal computer with offers pertaining to services, products that the first party does not have in stock, etc., that are available from one or more of the third parties.

Optionally, the apparatus 3000 of the exemplary embodiment further includes a preference information communicator.

The preference information communicator communicates preference information from the first party to the remote computer, through a computer network, such as the internet or another computer network.

The preference information defines general characteristics of products and services that the first party is interested in. For example, the preference information may include but is not limited to: a restriction for certain services to be provided only on certain hours of the day, a list of retailers the first party wants to trade with, retailers excluded from the list of retailers, etc.

The remote computer stores the preference information from the first party on a dedicated database, and uses the preference information for generating results for queries received from the first party, as described in further detail hereinbelow.

Optionally, the apparatus 3000 of the present exemplary embodiment further includes a proposal presenter in communication with the query issuer 330.

The proposal presenter is installed on the first party's POS (Point-of-sale) terminal computer, or on the portable device connectable to the first party's POS terminal computer.

The proposal presenter may be implemented as software, as hardware, or as a combination of software and hardware.

The proposal presenter receives the result of the query and presents a proposal based on the result, on a screen of the POS terminal computer, thus enhancing a sale transaction carried out using the POS terminal computer with the information provided by one or more third parties, as described in further detail hereinbelow.

Optionally, the information provided by the third parties includes a sale offer, and the result and the offer are based on the sale offer.

In one example, the proposal presenter presents a cross-selling proposal based on the query's result, by presenting information on an item related to an item sold to a client, using the POS terminal computer, on a screen of the POS terminal computer.

In a second example, the proposal presenter presents an up-selling proposal based on the query's result, by presenting information on an item more expensive than an item a customer wishes to buy, but more luxurious, using the POS terminal computer, on a screen of the POS terminal computer.

Optionally, the apparatus 3000 further includes one or more distributer utilities.

The distributer utility connects the first party to the third party's computer, and allows the first party to issue an on line order of a service or a product, directly to the third party. Optionally, the distributer utility allows the third party to grant a discount for the issued on line order, or to or present new offers to the first party.

Optionally, the apparatus 3000 further include an update utility, which provides for an automatic update of the apparatus 3000, or an update upon a user's request, as known in the art.

Optionally, the apparatus 3000 further includes an automatic recovery utility, which automatically restarts the apparatus 3000 (or selected parts of the apparatus 3000) in case of a problem.

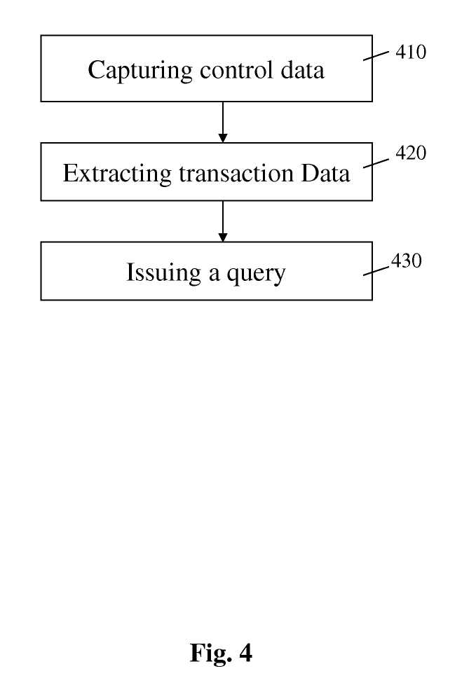

Reference is now made to FIG. 4, which is a flowchart illustrating a computer implemented method for point of sale enhancement, the method comprising steps the computer is programmed to perform.

Optionally, the method is implemented on apparatus 3000 installed on a POS (Point of sale) terminal computer, on a portable device connected to the POS terminal computer, or partially on the POS terminal and partially on the portable device, as described in further detail hereinabove.

In the exemplary method, control data of an operation on a POS (Point of sale) terminal computer of a first party or on a peripheral of the POS terminal computer of the first party is captured 410, say by the control data capturer 310, as described in further detail hereinabove.

The peripheral of the POS computer terminal may include, but is not limited to: a peripheral connected to the POS terminal computer (say a screen, a mouse, or a keyboard), a peripheral implemented on the POS terminal computer (say an internet connection), etc., as known in the art.

The peripheral may include, but is not restricted to: a bar code reader, a touch screen, a magnetic card reader, an internet connection, a modem, a computer mouse, a keyboard, a USB port, a graphical computer card, a printer, or any other peripheral device connected to the POS terminal computer.

In one example, the peripheral is a touch screen connected to the POS terminal computer, and the control data is generated upon a finger touch on a certain area of the touch screen (say a finger touch used to select a product among products presented on the touch screen).

In a second example, the peripheral is a printer in communication with the POS terminal computer, and the control data is generated upon a printing operation carried out on the printer.

Typically, the control data is communicated between the POS terminal computer and the peripheral, through one of several communication protocols, currently available for controlling peripherals of a POS terminal, as described in further detail hereinabove.

Optionally, control data is captured 410, by intercepting Microsoft™ Operating System messages, as described in further detail hereinbelow.

Optionally, the control data is captured 410, by hooking Postscript data from a UNIX operating system printer driver, etc., as described in further detail hereinbelow.

Optionally, the control data is captured 410 from a POS (Point-of-sale) software package (as known in the art) installed on the POS terminal computer.

Next, there is extracted 420 transaction data from the captured 410 control data.

Optionally, the extracted 420 transaction data pertains to a sale transaction carried out on the POS terminal computer of the first party.

Optionally, the transaction data is extracted upon identification of a predefined sequence of operations carried out on the POS terminal computer or on the terminal computer's peripheral, by extracting relevant information from the control data.

For example, when a scanning of an item's bar code is followed by a scanning of bar codes of several substitute items, the transaction data extractor 320 identifies a customer effort to choose among several alternative brands. Consequently, the transaction data extractor 320 extracts the sale transaction data (i.e. the brands of the items) from the control data.

In one example, the control data includes printing commands issued from a printer's driver.

Optionally, the printing commands include string parameters such as a sold product's name, quantity and price, to be printed on an invoice, as well parameters for controlling the position of the printing, color of printing, line skipping, etc.

The transaction data extracted 420 from the control data, may include but is not limited to a sold product's name, an amount sold, a price, etc.

Optionally, the control data includes Postscript printing commands, and the transaction data is extracted 420 from textual and graphical parameters of the Postscript commands, as described in further detail hereinbelow.

Then, a query is issued 430, say by the query issuer 330, as described in further detail hereinabove.

The issued 430 query is based on the extracted transaction data, and is used for retrieving information relevant for cross-selling, up-selling, or another sale activity, from a remote computer of a second party.

Optionally, the query includes data provided by a cashier who operates the POS terminal computer (say through a Graphical User Interface), in addition to the transaction data automatically extracted from the control data. For example, the cashier may provide data pertaining to a customer's age and sex, a customer's preference (say a vegetarian), etc.

Optionally, both the first party and the second party are retailers, say groceries, fashion boutiques, electric appliance stores, etc.

Optionally, the first party is a retailer, whereas the second party is an intermediary, and the remote computer of the intermediary receives the query and generates a result for the received query, using information provided by one or more third parties. The third party may be a second retailer, or another business entity. The third party provides the information to the intermediary through a remote communication to the remote computer, as described in further detail hereinabove.

Optionally, both the first party and the third party are retailers, say pharmacies, groceries, fashion boutiques, electric appliance stores, etc., as described in further detail hereinbelow.

In one example, the remote computer uses the query to retrieve information pertaining to a sales proposal originating from the third party, from a dedicated database, thus generating a result for the query.

The retrieved information may include, but is not limited to: promotional sale information, say information about a third party's product related to a product sold on the POS terminal computer, coupons available from a third party, tickets to a movie presented in a Cinema Theater not far from the first party at a discount, etc

Optionally, the retrieval of the information is based on data of the query as well as on preference information provided by the first party in an earlier stage, as described in further detail hereinabove.

Optionally, the retrieval of the information is further based on time and location. For example, the retrieval of information on the tickets to the movie may be restricted to a time period of no more than an hour before to movie starts.

Optionally, the exemplary method of the exemplary embodiment further includes a preliminary step of preference information communication.

In the preliminary step, preference information is communicated from the first party to the remote computer, through a computer network, such as the internet or another computer network, as described in further detail hereinabove.

The preference information defines general characteristics of products and services that the first party is interested in. For example, the preference information may include but is not limited to: a restriction for certain services to be provided only on certain hours of the day, a list of retailers the first party wants to trade with, retailers excluded from the list of retailers, etc.

The remote computer stores the preference information from the first party on a dedicated database, and uses the preference information in generating results for queries received from the first party.

Optionally, the exemplary method further includes a subsequent step of proposal presenting, say by the proposal presenter, as described in further detail hereinabove.

In the subsequent step, upon receiving the result of the query from the remote computer, a proposal based on the result is presented on a screen of the POS terminal computer, thus enhancing a sale transaction carried out using the POS terminal computer with the information provided by one or more third parties, as described in further detail hereinbelow.

Optionally, the information provided by the third parties includes a sale offer, and the result and the proposal are based on the sale offer.

In one example, the proposal is a cross-selling proposal based on the query's result, presented by presenting information on an item related to an item sold to a client, using the POS terminal computer, on a screen of the POS terminal computer.

In a second example, the proposal is an up-selling proposal based on the query's result, presented by presenting information on an item more expensive than an item a customer wishes to buy, but more luxurious, on a screen of the POS terminal computer.

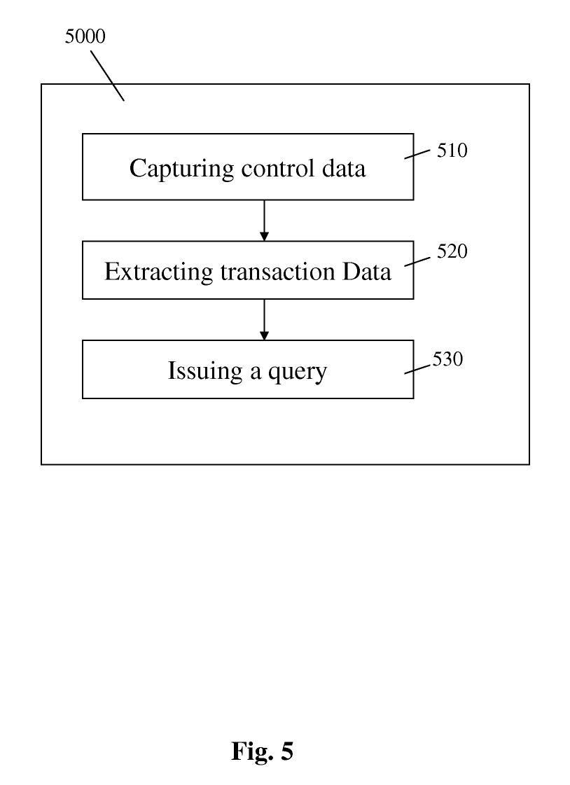

Reference is now made to FIG. 5, which is block diagram schematically illustrating a computer readable medium storing computer executable instructions for performing steps of point of sale enhancement.

According to an exemplary embodiment of the present invention, there is provided a computer readable medium 5000, such as a CD-ROM, a USB-Memory, a USB Memory and Communication plug-in device (such as a Nova-Media iCON 431 Modem and Memory Stick), a USB Portable Hard Disk, a diskette, etc.

The computer readable medium 5000 stores computer executable instructions, for performing steps of point of sale enhancement, according to an exemplary embodiment of the present invention.

The computer readable medium 5000 may allow enhancement of a POS (Point-of-sale) terminal computer with a functionality provided by the computer executable instructions, say using the client program 330, as described in further detail and illustrated using FIG. 2 hereinabove.

Preferably, using the computer readable medium 5000, the POS terminal computer may be enhanced, in a manner which may be independent of the POS terminal computer's original POS software, as described in further detail hereinabove.

The computer executable instructions include a step in which control data of an operation on a POS (Point of sale) terminal computer of a first party or on a peripheral connected to the POS terminal computer of the first party, is captured 510, as described in further detail hereinabove.

The peripheral may include, but is not restricted to: a bar code reader, a touch screen, a magnetic card reader, an internet connection, a modem, a computer mouse, a keyboard, a USB port, a graphical computer card, a printer, or any other peripheral device connected to the POS terminal computer.

Typically, the control data is communicated between the POS terminal computer and the peripheral (such as a touch screen, a printer, a bar code reader, etc.), through one of a several communication protocols currently available for controlling peripherals of a POS terminal, as described in further detail hereinabove.

Optionally, control data is captured 510, by intercepting Microsoft™ Operating System messages, as described in further detail hereinbelow.

Optionally, the control data is captured 510, by hooking Postscript data from a UNIX operating system printer driver, etc., as described in further detail hereinabove.

The computer executable instructions further include a step in which, there is extracted 520 transaction data from the captured 510 control data.

Optionally, the extracted 520 transaction data pertains to a sale transaction carried out on the POS terminal computer of the first party.

Optionally, the transaction data is extracted by identifying a predefined sequence of operations carried out on the POS terminal computer or on the terminal computer's peripheral, and extracting relevant information from the control data.

For example, when a scanning of an item's bar code is followed by a scanning of bar codes of several substitute items, there may be identified a customer's effort to choose among several alternative brands. Consequently, there is extracted the sale transaction data (i.e. the brands of the items) from the control data, as described in further detail hereinabove.

In one example, the control data includes printing commands issued from a printer's driver.

Optionally, the printing commands include string parameters such as a sold product's name, quantity and price, to be printed on an invoice, as well parameters for controlling the position of the printing, color of printing, line skipping, etc.

The transaction data extracted 520 from the control data, may include but is not limited to a sold product's name, an amount sold, a price, etc.

Optionally, the control data includes Postscript printing commands, and the transaction data is extracted 520 from textual and graphical parameters of the Postscript commands, as described in further detail hereinabove.

The computer executable instructions further include a step in which, a query is issued 530, as described in further detail hereinabove.

The issued 530 query is based on the extracted transaction data, and is used for retrieving information relevant for cross-selling, up-selling, or another sale activity, from a remote computer of a second party.

Optionally, the query includes data provided by a cashier who operates the POS terminal computer (say through a Graphical User Interface), in addition to the transaction data automatically extracted from the control data. For example, the cashier may provide data pertaining to a customer's age, sex, etc.

Optionally, both the first party and the second party are retailers, say groceries, fashion boutiques, electric appliance stores, etc.

Optionally, the first party is a retailer, whereas the second party is an intermediary, and the remote computer of the intermediary receives the query and generates a result for the received query, using information provided by one or more third parties. The third party may be a second retailer, or another business entity. The third party provides the information to the intermediary through a remote communication to the remote computer, as described in further detail hereinabove.

Optionally, both the first party and the third party are retailers, say pharmacies, groceries, fashion boutiques, electric appliance stores, etc., as described in further detail hereinbelow.

In one example, the remote computer uses the query to retrieve information pertaining to a sales proposal originating from the third party, from a dedicated database, thus generating a result for the query.

The retrieved information may include, but is not limited to: promotional sale information, say information about a third party's product related to a product sold on the POS terminal computer, coupons available from a third party, a movie presented in a Cinema Theater not far from the first party, etc.

Optionally, the computer executable instructions further include a preliminary step of preference information communication, as described in further detail hereinabove.

In the preliminary step, preference information is communicated from the first party to the remote computer, through a computer network, such as the internet or another computer network.

The preference information defines general characteristics of products and services that the first party is interested in. For example, the preference information may include but is not limited to: a restriction for certain services to be provided only on certain hours of the day, a list of retailers the first party wants to trade with, retailers excluded from the list of retailers, etc.

The remote computer stores the preference information from the first party on a dedicated database, and uses the preference information in generating results for queries received from the first party.

Optionally, the computer executable instructions further include a subsequent step of proposal presenting, as described in further detail hereinabove.

In the subsequent step, upon receiving the result of the query from the remote computer, a proposal based on the result is presented on a screen of the POS terminal computer, thus enhancing a sale transaction carried out using the POS terminal computer with the information provided by one or more third parties, as described in further detail hereinabove.

Optionally, the information provided by the third parties includes a sale offer, and the result and the proposal are based on the sale offer.

In one example, the proposal is a cross-selling proposal based on the query's result, presented by presenting information on an item related to an item sold to a client, using the POS terminal computer, on a screen of the POS terminal computer.

In a second example, the proposal is an up-selling proposal based on the query's result, presented by presenting information on an item more expensive than an item a customer wishes to buy, but more luxurious, on a screen of the POS terminal computer.

With exemplary embodiments of the present invention there is provided an ability to offer cross and up sell offerings between the retailers to other separated and independent retailers and third party companies. The ability is provided in context of time (time of the sale transaction), place (location of the POS terminal computer), human interaction (cashier at the point of sale), sale parameters (transaction data extracted from the POS terminal computer, peripherals or both).

The system and methods according to exemplary embodiments of the present invention may constitute a virtual network which opens the retailer to many opportunities of cross and up selling, by removing the barrier of specific point of sale vendor and retailer standard offering, as known in the art.

The virtual network enables each retailer to register to the intermediary's database for relevant offerings (buy or sell) based on his preferences, as described in further detail hereinabove.

The virtual network establishes a community of independent parties, each party with his own POS terminal computers, where each of the parties communicates information on products or services the party is interested in, product or services the party can offer, etc., to a remote computer of an intermediary party. The remote party's computer automatically mediates between the parties, by generating responses to queries issued against the remote computer by one or more of the parties, as described in further detail hereinabove.

It is expected that during the life of this patent many relevant devices and systems will be developed and the scope of the terms herein, particularly of the terms “Computer”, “Point of Sale terminal”, “Peripheral”, “Internet”, “Screen”, “Touch screen”, “Printer”, “USB Memory”, “Modem”, and “Database” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for point of sale enhancement, the system comprising:
a control data capturer, configured to capture control data of an operation on a POS (Point of sale) terminal computer of a first party;
a transaction data extractor, in communication with the control data capturer, configured to extract transaction data from the captured control data;
a query issuer, in communication with the transaction data extractor, configured to issue a query based on the extracted transaction data; and
a remote computer of an intermediary party, in remote communication with the query issuer, configured to receive the query and generate a result for the received query, using information provided by a third party through remote communication to the remote computer.

2. The system of claim 1, wherein the operation is performed on a peripheral of the POS terminal computer.

3. The system of claim 1, further comprising a proposal presenter configured to present a proposal based on the received result on a screen of the POS terminal computer.

4. The system of claim 1, wherein the first party and the third party are retailers.

5. The system of claim 1, wherein at least one of the control data capturer, transaction data extractor and query issuer, is implemented on a portable device connectable to the POS terminal computer.

6. The system of claim 1, wherein at least one of the control data capturer, transaction data extractor and query issuer, is implemented on a computer in communication with the POS terminal computer.

7. The system of claim 1, further comprising an information communicator, implemented on a computer of the third party, configured to communicate the information from the third party to the remote computer.

8. An apparatus for point of sale enhancement, the apparatus comprising:
a control data capturer, configured to capture control data of an operation on a POS (Point of sale) terminal computer of a first party;
a transaction data extractor, in communication with the control data capturer, configured to extract transaction data from the captured control data; and
a query issuer, in communication with the transaction data extractor, configured to issue a query based on the extracted transaction data against a remote computer of a second party.

9. The apparatus of claim 8, wherein the operation is performed on a peripheral of the POS terminal computer.

10. The apparatus of claim 8, further comprising a proposal presenter configured to present a proposal based on the received result on a screen of the POS terminal computer.

11. The apparatus of claim 8, wherein the first party and the second party are retailers.

12. The apparatus of claim 8, wherein the second party is an intermediary and the remote computer is configured to receive the query and generate a result for the received query, using information provided by a third party through remote communication to the remote computer, and wherein the first party and the third party are retailers.

13. The apparatus of claim 8, wherein at least one of the control data capturer, transaction data extractor and query issuer, is implemented on a portable device connectable to the POS terminal computer.

14. The apparatus of claim 8, wherein at least one of the control data capturer, transaction data extractor and query issuer, is implemented on a computer in communication with the POS terminal computer.

15. A computer implemented method for point of sale enhancement, the method comprising steps the computer is programmed to perform, the steps comprising:
a) capturing control data of an operation on a POS (Point of sale) terminal computer of a first party;
b) extracting transaction data from the captured control data; and
c) issuing a query based on the extracted transaction data against a remote computer of a second party.

16. The method of claim 15, wherein the operation is performed on a peripheral of the POS terminal computer.

17. The method of claim 15, further comprising presenting a proposal based on the received result on a screen of the POS terminal computer.

18. The method of claim 15, wherein the parties are retailers.

19. The method of claim 15, wherein the second party is an intermediary and the remote computer is configured to receive the query and generate a result for the received query, using information provided by a third party through remote communication to the remote computer, and wherein the first party and the third party are retailers.

20. A computer readable medium storing computer executable instructions for performing steps of point of sale enhancement, the steps comprising:
a) capturing control data of an operation on a POS (Point of sale) terminal computer of a first party;
b) extracting transaction data from the captured control data; and
c) issuing a query based on the extracted transaction data against a remote computer of a second party.

21. The computer readable medium of claim 20, wherein the operation is performed on a peripheral of the POS terminal computer.

22. The computer readable medium of claim 20, wherein the steps further comprise a step of presenting a proposal based on the received result on a screen of the POS terminal computer.

23. The computer readable medium of claim 20, wherein the parties are retailers.

24. The computer readable medium of claim 20, wherein the second party is an intermediary and the remote computer is configured to receive the query and generate a result for the received query, using information provided by a third party through remote communication to the remote computer, and wherein the first party and the third party are retailers.
